(19) United States
(12) Patent Application Publication
(10) Pub. No.: US 2021/0073907 A1
(43) Pub. Date: Mar. 11, 2021

(54) PEER-TO-PEER CLOUD-BASED CREDIT LENDING

(71) Applicant: VISA INTERNATIONAL SERVICE ASSOCIATION, San Francisco, CA (US)

(72) Inventors: Ram Vibhakar Suthagar, Kolkata (SG); Dipto Sarkar, Kolkata (SG); Balaji Kadappan, Kolkata (SG); Dilipa Rout, Kolkata (SG); Arup Das, Kolkata (SG)

(21) Appl. No.: 16/563,779

(22) Filed: Sep. 6, 2019

(51) Int. Cl. G06Q 40/02; G06Q 20/22

(52) U.S. Cl. CPC G06Q 40/025; G06Q 20/223

(57) ABSTRACT

A system for conducting credit issuance via a computer network platform. A payment processing network for a connecting a borrower and one or more lenders and a payment processing server receives, via a graphical user interface (GUI), a loan request from a mobile device of the borrower. The GUI includes data fields for receiving data including a borrower ID associated with the server and an amount of the loan request. The payment processing server, based on the borrower ID, identifies one or more additional data without obtaining a credit rating of the borrower from a credit agency. The payment processing server generates a credibility score based on the one or more identified data of the borrower. The payment processing server further generates a maximum loan amount based on the credibility score. The payment processing server further provides the credibility score to one or more lenders.

### TECHNICAL FIELD

Embodiments discussed herein generally relate to a peer-to-peer cloud-based platform to facilitate diversified credit lending.

### BACKGROUND

Small businesses, like consumers and banking institutions, engage in various business transactions and may wish to expand their operations. As such, sometimes they may wish to engage a lending institution for a loan. Regardless of the actual loan amounts, however, small businesses usually are unable to obtain the funding at an interest rate that is acceptable. As such, many times, the need for additional capital is met by assistances from friends and families of the small businesses.

The success of the Internet also opens opportunities for the small business owners or merchants to secure additional funding via online portals, such as crowdsourcing platforms. There are two main types of crowdfunding: a reward type where individual contributors donate funds—usually in small amounts—to your crowdfunding campaign in exchange for some kind of a reward. The reward could be a preordered purchase of your product, a shout-out on a website, or even a token of appreciation. The second type includes equity, which is where the platform connects the small business to investors who are willing to make larger donations in exchange for a stake in your business.

Under the different types, some platforms allow the business owner to keep whatever funds you raise while others only let you keep the funds if the campaign is fully successful (commonly called “all-or-nothing campaigns”).

Some sites offer other types of crowdfunding that don't fall neatly into the reward or equity categories. For example, some function more like charitable contributions, and others can be used to create a steady source of income for creators like artists and writers.

Other than these sources, the small business owners may have to resort to banking institutions for loans, which in many jurisdictions, require the small business owners to provide a credit score of some sort. However, there are no other parameters or factors that are independent of the credit score to demonstrate the creditworthiness of the small businesses.

Overall, FIG. 1 illustrates a typical diagram 100 showing how credit lending or loan is conducted for small business owners.

Therefore, embodiments attempt to create a technical solution to address the deficiencies of the challenges above.

### SUMMARY

Embodiments create a technical solution to the above challenges by modifying or updating the existing approaches. Aspects of embodiments enable an improved capability to accept additional credit lending parameters from a payment processing network. In one embodiment, instead of relying on the traditional requirements of obtaining a credit score of a borrower, aspects of embodiments provide an independent source of creditworthiness from the payment processing network. For example, the payment processing network may provide merchant related data and parameters, such as historical merchant transaction amount, transaction related information, merchant peer information, etc., for the lender to determine whether to extend credit to the borrower.

### BRIEF DESCRIPTION OF THE DRAWINGS

Persons of ordinary skill in the art may appreciate that elements in the figures are illustrated for simplicity and clarity so not all connections and options have been shown. For example, common but well-understood elements that are useful or necessary in a commercially feasible embodiment may often not be depicted in order to facilitate a less obstructed view of these various embodiments of the present disclosure. It may be further appreciated that certain actions and/or steps may be described or depicted in a particular order of occurrence while those skilled in the art may understand that such specificity with respect to sequence is not actually required. It may also be understood that the terms and expressions used herein may be defined with respect to their corresponding respective areas of inquiry and study except where specific meanings have otherwise been set forth herein.

FIG. 1 is a diagram illustrating an existing approach to credit lending.

FIG. 2 is a diagram illustrating a peer-to-peer cloud-based credit lending according to one embodiment.

FIG. 3A is another diagram illustrating a peer-to-peer cloud-based credit lending according to one embodiment.

FIGS. 3B-3C are screenshots of a user portal for requesting a credit according to one embodiment.

FIG. 3D is a diagram illustrating a flow for fund transfer from a lender to a borrower according to one embodiment.

FIG. 4 is a diagram illustrating one or more parameters for a credit request according to one embodiment.

FIG. 5 is a flow chart illustrating a method according to one embodiment.

FIG. 6 is a diagram illustrating a portable computing device according to one embodiment.

FIG. 7 is a diagram illustrating a computing device according to one embodiment.

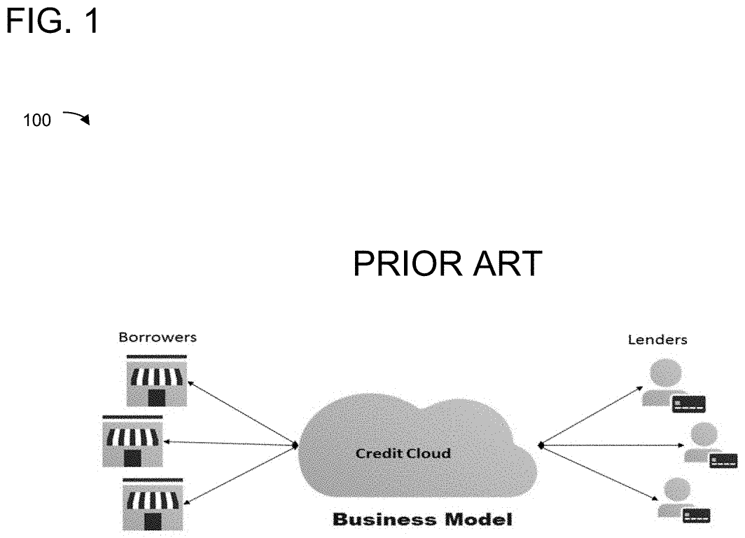

### DETAILED DESCRIPTION

Embodiments may now be described more fully with reference to the accompanying drawings, which form a part hereof, and which show, by way of illustration, specific exemplary embodiments which may be practiced. These illustrations and exemplary embodiments may be presented with the understanding that the present disclosure is an exemplification of the principles of one or more embodiments and may not be intended to limit any one of the embodiments illustrated. Embodiments may be embodied in many different forms and should not be construed as limited to the embodiments set forth herein; rather, these embodiments are provided so that this disclosure may be thorough and complete, and may fully convey the scope of embodiments to those skilled in the art. Among other things, the present invention may be embodied as methods, systems, computer readable media, apparatuses, or devices. Accordingly, the present invention may take the form of an entirely hardware embodiment, an entirely software embodiment, or an embodiment combining software and hardware aspects. The following detailed description may, therefore, not to be taken in a limiting sense.

Embodiments create a cloud platform and a user application providing convenient credit lending for merchants. Instead of using existing credit score data, which relies on a score provided from a third party (e.g., credit bureaus), which may include incorrect or maybe compromised data, aspects of the invention provide an alternative credit lending platform. In addition, embodiments first validate merchant's identify via a merchant location before converting one or existing data points to a credibility score, a maximum credit amount, or the like.

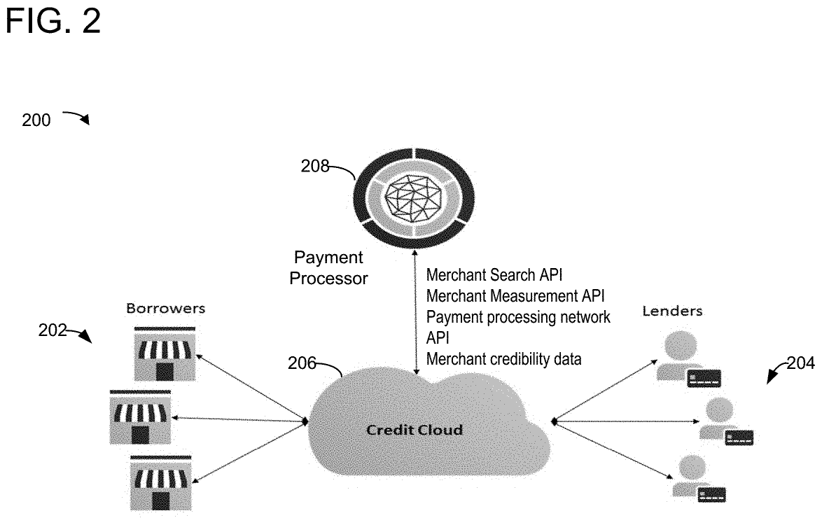

Referring now to FIG. 2, a diagram illustrating a credit cloud system 200 according to one embodiment. In one example, the credit cloud system 200 enables one or more merchant borrowers (or “borrower” for the sake of simplicity) for 202 engage with one or more lenders 204 via a cloud service 206. In another embodiment, the credit cloud system 200 may exchange or communicate with a payment processor 208 to receive and send data to facilitate the one or more borrowers 202 to apply for a credit from the one or more lenders 204. In one embodiment, the one or more lenders 204 may include financial institutions, such as banks, brokerage firms, security firms, fund managers, other merchants, investors, or individuals who may have funds available as a source to lend to the borrower 202. In another example, the one or more lenders 204 may include an entity that provides funding or extending credit (e.g., a financial institution such as a bank), an investment institution with funds from one or more investors with a defined investment direction or need to comply with government regulations or rules, or a crowdsourcing entity that pools funds from individuals for a specific purpose and duration.

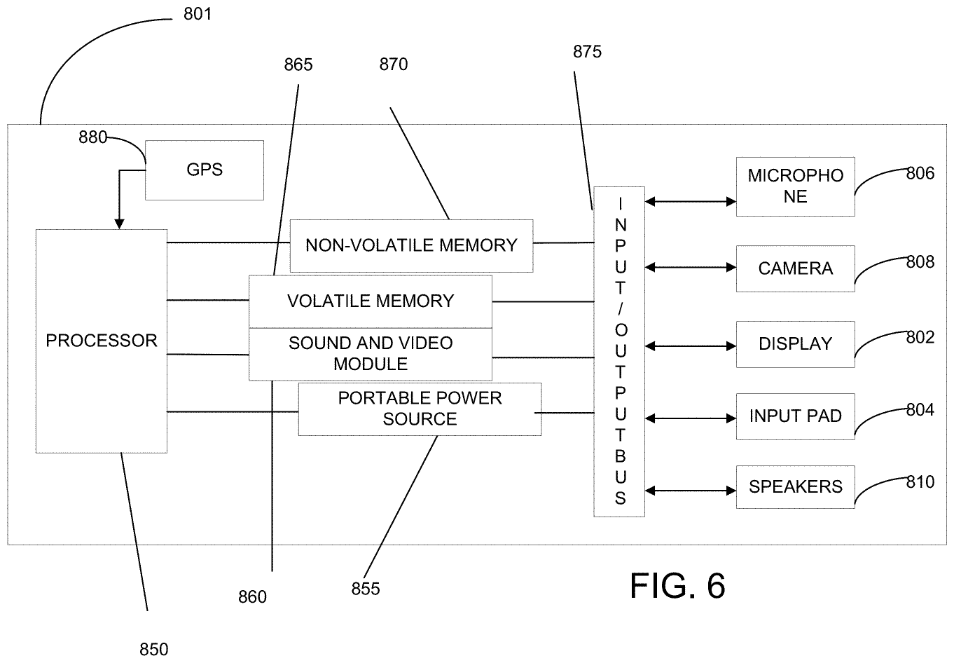

In one embodiment, the borrower 202 may first need to access the credit cloud 206. For example, the borrower 202 may use a personal device, such as the one shown in FIG. 6 (e.g., portable computing device 801). The borrower 202 may visit a portal or a website of the credit cloud 206 to begin the process. In another embodiment, the borrower 202 may be a merchant and has an merchant account with the payment processor 208. As such, the payment processor 208 may provide the portal to the credit cloud 206 as part of the merchant account.

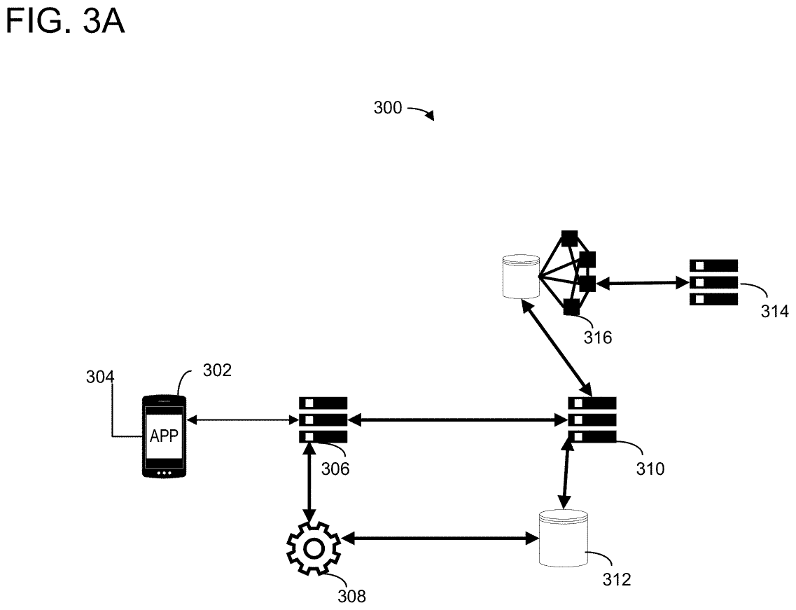

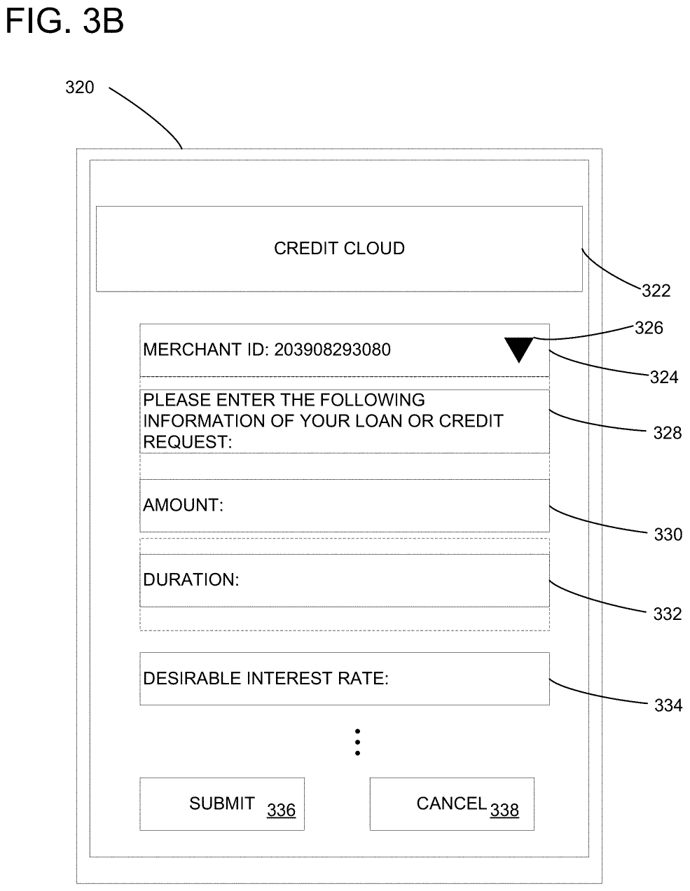

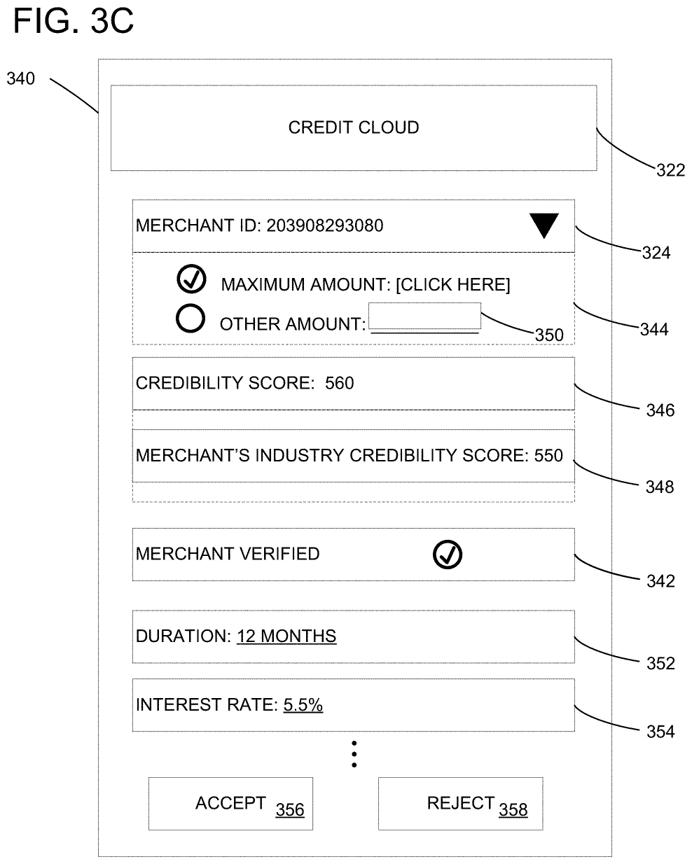

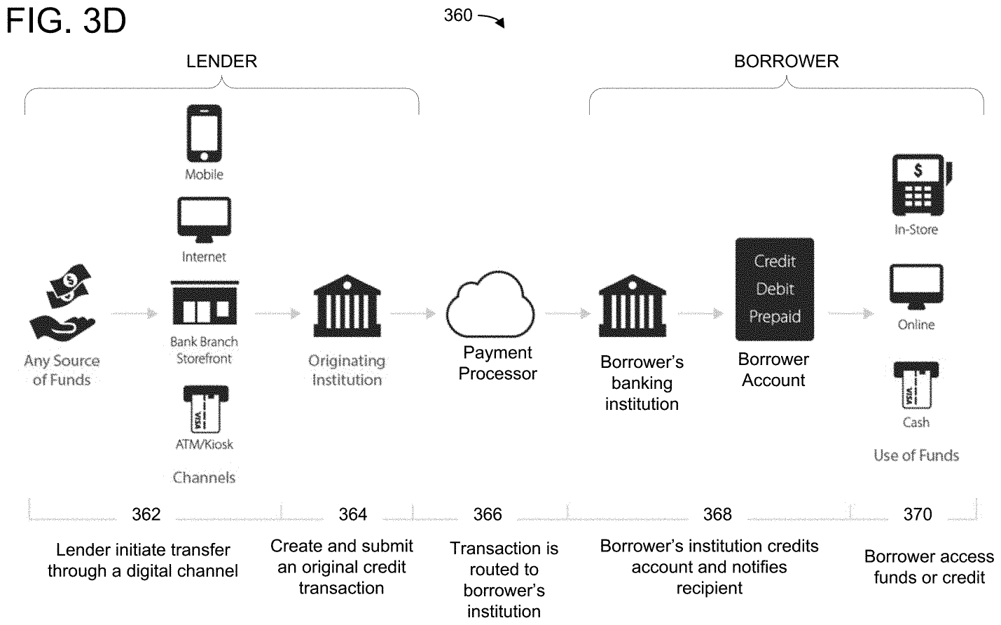

In another embodiment, the payment processor 208 may provide an app or application to be installed on a mobile device for quick and convenient access to the credit cloud 206. To further illustrate the system 200, referring now to FIG. 3A, another diagram illustrates a system 300 for providing a cloud-based credit lending platform to the borrower 202 according to one embodiment. In this example, the borrower 202 may be a merchant with the payment processor 208, which manages and operates a payment processing network. For example, the payment processing network of the payment processor 208 may include a comprehensive network of merchants, acquirers, and issuers that rely on the payment processor 208 to handle transactions conducted among a consumer, a merchant, an acquirer, and an issuer. As such, the payment processing network may include various merchant service components, such as application programming interface (API) for handling various data input and function calls, analytic tools to assist the merchant to grow its business, fraud prevention measures and solutions to reduce fraudulent transactions, etc. In one embodiment, the borrower 202 may use a mobile device 302 to install an app 304 to access the credit cloud 206. In one example, the app 304 may provide a prompt to allow the borrower 202 to enter credentials to sign-in to the merchant account that the borrower 202 already has with the payment processor 208.

In another embodiment, once the app 304 logs to the credit cloud 206, which may be hosted by a server 306. In one embodiment, it is to be understood that there may be a cluster of servers that host or serve the credit cloud with a combination of front end servers, backend servers 310, database servers 316, data storage units 312, and other hardware devices. In addition, the system 300 may include a configuration portal 308 to configure databases 312, the backend servers 310, and the database servers 316. Furthermore, the system 300 may connect to one or more third party service providers, vendors, affiliates, etc. For example, the system 300 may be connected to a lender server 314 via the database servers 316 for exchanging data with the lender server 314.

Referring to FIG. 3B, an exemplary screenshot graphical user interface (GUI) 320 illustrates a view for the borrower 202 once the borrower 202 logs into the account and has selected credit cloud to request for a credit or a loan. The GUI 320 may include a title bar 322 for identifying the GUI (e.g., credit cloud). An ID bar 324 identifies the merchant ID number associated with the payment processor 208. In one embodiment, the borrower 202 may have multiple accounts with the payment processor 208. As such, a more detail indicia (e.g., a down arrow) 326 may enable the borrower 202 to select sub-accounts. In such an example, the ID bar 324 may identify the default account for the borrower 202.

In another embodiment, the GUI 320 may include a set of request related information. For example, a title bar 328 may further request details of the loan or credit request. For example, a field 330 may ask the borrower 202 to enter an amount of the loan or credit; a field 332 may ask the borrower 202 to enter a desirable duration of the loan or credit; a field 334 may ask the borrower 202 to enter a desirable interest rate. It is to be understood that other details may be entered without departing from the spirit and scope of the embodiments.

Once the borrower 202 is ready, the borrower 202 may select or activate a submit button 336. On the other hand, if the borrower 202 wishes to change his or her mind, the borrower 202 may select or activate a cancel button 338 instead.

Once the submit button 336 has been selected, the payment processor 208 may receive the information entered by the borrower 202. As an initial step, the app 304 may call a merchant search API (e.g., one of the APIs hosted or supported by the payment processor 208) to verify the borrower's identity. In one embodiment, in addition to the name of the borrower that may be verified, the borrower's location or registered location may be verified based on the merchant search API. In one embodiment, referring now to FIG. 3C, another GUI 340 may be presented to the borrower 202 after he or she selects or activates the submit button 336. In the GUI 340, a verified field 342 may indicate that the merchant or borrower is verified (e.g., via a checkmark indicia). After receiving the merchant ID from the app 304, the payment processor 208 may use the merchant ID to retrieve or identify additional merchant information. For example, the payment processor 208 may reference the merchant ID in a number of data processing functions and APIs. For example, the merchant ID may be used as a key of Acquirer Processor Control Records (Acquirer PCR), Acquirer Bin, and Card Acceptor ID and each of these may be used in one or more APIs.

Moreover, the payment processor 208 may retrieve additional data based on the merchant ID to calculate or determine a credibility score and a maximum amount of the credit or loan. In one example, the merchant may establish a profile with the payment processor 208 and such profile may include, in addition to the basic information of the merchant (e.g., name, address, contact information, etc.), transactional data for the merchant. In one embodiment, the payment processor 208 may retrieve one or more of the following data from the profile:

Merchant Category Group (MCG) Level and Merchant Category Code (MCC) Level

Metropolitan Statistical Area (MSA) Level and Postal Code Level

GroupList=Cardholder and accountFundingSource

GroupList=Cardholder and platform ID

GroupList=Cardholder and eciIndicator

GroupList=Cardholder and posEntryMode

GroupList=Chargebacks and accountFundingSource

GroupList=Chargebacks and platform ID

GroupList=Chargebacks and eciIndicator

GroupList=Chargebacks and posEntryMode

In one embodiment, the payment processor 208 may review the past transaction records to determine or evaluate the credibility score and the maximum amount of the credit or loan.

For example, the transaction records may organized in specialized cluster configurations (e.g., Hadoop cluster) so that the large volume data received from transactions that the payment processor 208 may be properly handled and be associated with the merchant. In addition, data received via the cluster may be stored in specific tables that is specialized for storing large volume data. For example, a given merchant's transaction data may be received in a form of a table that may include one or more cells with headings. Each of the cells may identify or reference a value (e.g., a direct reference) or an output from processing an API (e.g., an indirect reference). In another embodiment, one of the cells may identify or reference a schema, such as GMR or OPGA.

In another embodiment, as illustrated in FIG. 3C, the GUI 340 of the app 304 may provide the maximum amount in a field 344 and the credibility score in a field 346. In another aspect, the GUI 340 may hide the maximum amount by requiring the borrower 202 to select or activate “click here”. In a further embodiment, the payment processor 208 may enable, via the GUI 340, the borrower 202 to enter a higher amount than the maximum amount for reconsideration by the payment processor 208.

As one of the benefits of aspects of embodiments, the payment processor 208, the credit cloud 206, and the system 200/300 as a whole, the system 200/300 no longer adheres to the existing paradigm of requiring a static or one-time credit score of the operator of a small business or merchant. Instead, aspects of embodiments enable the payment processor 208 to respond to the loan or credit request in real time or substantially real time to evaluate and determine a credit or loan amount. As such, the determination of the maximum amount and the ability to allow the borrower 202 to counter a different amount may be conducted seamlessly so that the borrower 202 may obtain the result instantly. In addition, the determination of the borrower's credibility score is not based on a credit report from credit bureaus that may have outdated information or the score may be compromised by data breaches. Aspects of embodiments utilize current and practical data based on performances of the merchant/borrower so that the credibility score generated by the payment processor 208 is not only accurate but pertinent and direct to the one or more lenders 204, who wish to know a degree of risk of non-repayment by the borrower 202.

In one embodiment, the GUI 340 may, for reference, display a related information, such as “merchant's industry credibility score”. In another embodiment, the borrower 202 may provide additional term of the loan or credit, such as a duration in a field 352, and an interest rate in a field 354.

Once the borrower 202 wishes to accept the terms that include the maximum amount, the borrower 202 may select or activate an accept button 356. The borrower 202 may also reject the offer by selecting or activating a reject button 358.

In one embodiment, the payment processor 208, before receiving acceptance from the borrower 202, may provide the credibility score, the maximum amount, and other terms of the loan or credit lending to the one or more lenders 204 who wish to engage with the credit cloud platform. As such, the one or more lenders 204 may have responded in the background while the payment processor 208 awaits the acceptance from the borrower 202. In another embodiment, as illustrated by FIG. 3A, the servers (e.g., server 314) of the one or more of lenders 204 may be connected to the database servers 316 to access a copy of the credibility score, the maximum amount, and the other terms as provided by the payment processor 208. In one embodiment, the one or more lenders 204 may optionally pre-approve the merchant/borrower 202 in the background while awaiting for the acceptance from the borrower 202.

In another embodiment, the payment processor 208 may, instead of showing FIG. 3C where the accept button 356 and the reject button 358 as requiring the borrower 202 to affirmatively and explicitly agree to the terms, bypass the affirmative or explicit acceptance GUI 340. Instead, the payment processor 208 may, in response to receive the request from the borrower 202 with the amount of the request and other terms, determine the credibility score, the maximum amount and other terms, and if there is a lender who wishes to accept the terms set forth by the borrower 202, may automatically grant the request of the loan or credit lending.

In one embodiment, once the request has been matched with a lender, the payment processor 208 may initiate the fund transfer or the credit lending processing between the lender and the borrower. According to FIG. 3D, a flow diagram 360 illustrates an exemplified process. For example, at 362, a lender may initiate a transfer (e.g., credit or loan) through a digital channel. At 364, the lender's institution may next, after receiving a request for the transfer, create and submit an original credit transaction (OCT) and, after going through the payment processor (e.g., payment processor 208), the transaction is routed to the borrower's institution at 366. Depending on how the merchant/borrower has established the account with the payment processor 208, the borrower's banking institution may credit the account of the borrower and may notify the borrower at 368. At 370, the borrower may access his or her account to access the funds or credit.

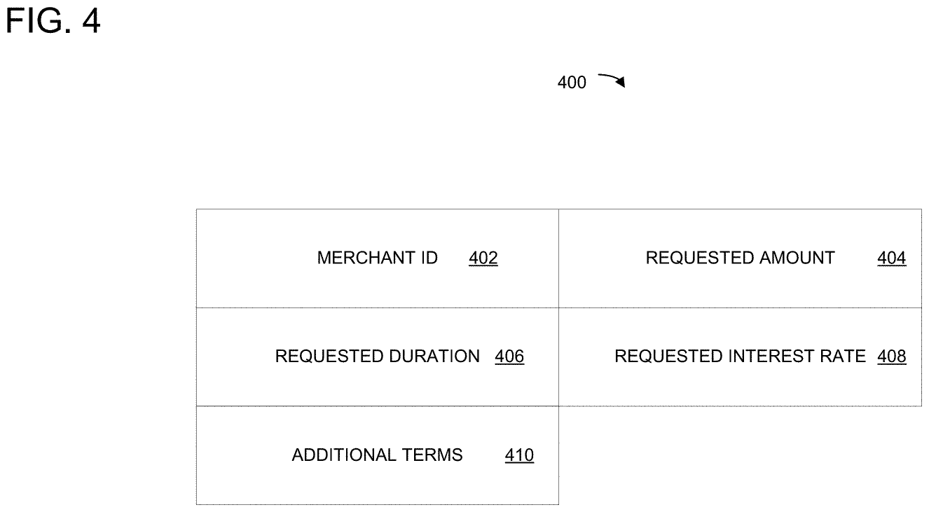

Referring now to FIG. 4, a diagram 400 illustrates a set of parameters that the app 304 may receive before sending to the payment processor 208 for the request to be processed. In one embodiment, the request may include at least the parameters: a merchant ID 402, a requested amount 404, a requested duration 406, a requested interest rate 408, and any additional terms 410.

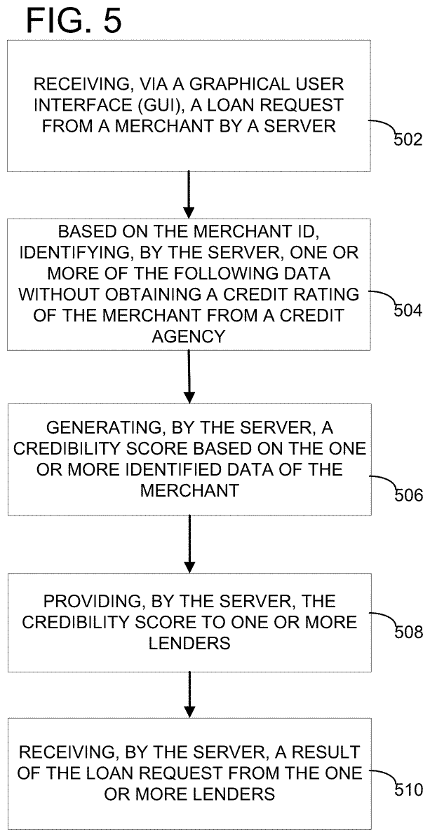

Referring now to FIG. 5, a flow chart illustrating a method for creating a credit cloud platform according to one embodiment. At 502, the payment processor may receive, via a graphical user interface (GUI), a loan request from a merchant. In one embodiment, the GUI includes data fields for receiving data from the merchant, and the data include a merchant ID associated with the payment processor and a requested amount of the loan request. At 504, based on the merchant ID, identifying, by the server, one or more of the following data without obtaining a credit rating of the merchant from a credit agency: historical data of transactions processed between the server and the merchant, a location of the merchant, a peer group of the merchant, and statistical data of performance of the merchant.

At 506, the payment processor 208 may generate a credibility score based on the one or more identified data of the merchant. In another embodiment, the payment processor 208 may generate a maximum loan amount in response to the generated credibility score. The payment processor 208 may provide the credibility score to the one or more lenders at 508. At 510, the payment processor 208 may receive a result from the one or more lenders regarding the loan request.

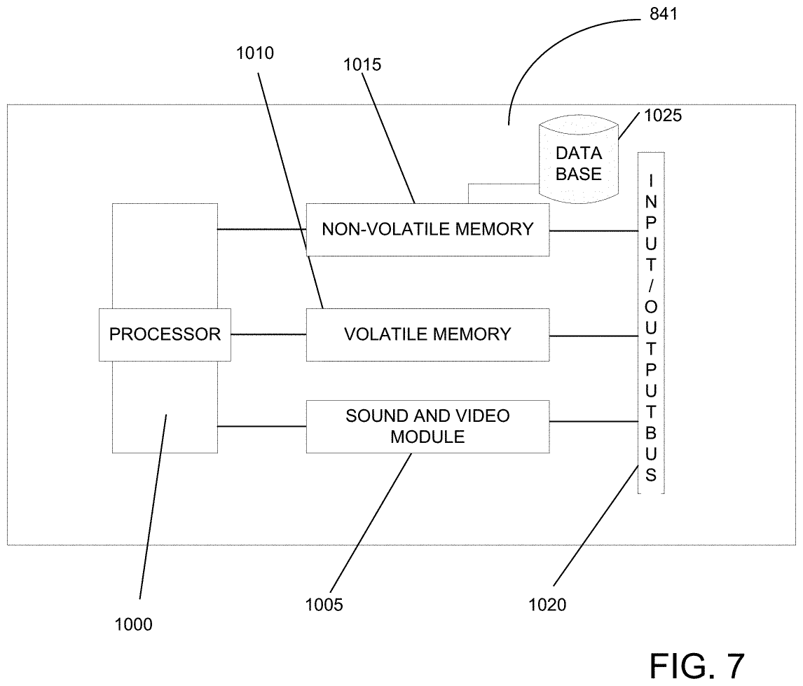

FIG. 6 may be a high level illustration of a portable computing device 801 communicating with a remote computing device 841 in FIG. 7 but the application may be stored and accessed in a variety of ways. In addition, the application may be obtained in a variety of ways such as from an app store, from a web site, from a store Wi-Fi system, etc. There may be various versions of the application to take advantage of the benefits of different computing devices, different languages and different API platforms.

In one embodiment, a portable computing device 801 may be a mobile device 108 that operates using a portable power source 855 such as a battery. The portable computing device 801 may also have a display 802 which may or may not be a touch sensitive display. More specifically, the display 802 may have a capacitance sensor, for example, that may be used to provide input data to the portable computing device 801. In other embodiments, an input pad 804 such as arrows, scroll wheels, keyboards, etc., may be used to provide inputs to the portable computing device 801. In addition, the portable computing device 801 may have a microphone 806 which may accept and store verbal data, a camera 808 to accept images and a speaker 810 to communicate sounds.

The portable computing device 801 may be able to communicate with a computing device 841 or a plurality of computing devices 841 that make up a cloud of computing devices 811. The portable computing device 801 may be able to communicate in a variety of ways. In some embodiments, the communication may be wired such as through an Ethernet cable, a USB cable or RJ6 cable. In other embodiments, the communication may be wireless such as through Wi-Fi® (802.11 standard), BLUETOOTH, cellular communication or near field communication devices. The communication may be direct to the computing device 841 or may be through a communication network 102 such as cellular service, through the Internet, through a private network, through BLUETOOTH, etc., FIG. 6 may be a simplified illustration of the physical elements that make up a portable computing device 801 and FIG. 7 may be a simplified illustration of the physical elements that make up a server type computing device 841.

FIG. 6 may be a sample portable computing device 801 that is physically configured according to be part of the system. The portable computing device 801 may have a processor 850 that is physically configured according to computer executable instructions. It may have a portable power supply 855 such as a battery which may be rechargeable. It may also have a sound and video module 860 which assists in displaying video and sound and may turn off when not in use to conserve power and battery life. The portable computing device 801 may also have non-volatile memory 865 and volatile memory 870. It may have GPS capabilities 880 that may be a separate circuit or may be part of the processor 850. There also may be an input/output bus 875 that shuttles data to and from the various user input devices such as the microphone 806, the camera 808 and other inputs, such as the input pad 804, the display 802, and the speakers 810, etc., It also may control of communicating with the networks, either through wireless or wired devices. Of course, this is just one embodiment of the portable computing device 801 and the number and types of portable computing devices 801 is limited only by the imagination.

As a result of the system, better information may be provided to a user at a point of sale. The information may be user specific and may be required to be over a threshold of relevance. As a result, users may make better informed decisions. The system is more than just speeding a process but uses a computing system to achieve a better outcome.

The physical elements that make up the remote computing device 841 may be further illustrated in FIG. 7. At a high level, the computing device 841 may include a digital storage such as a magnetic disk, an optical disk, flash storage, non-volatile storage, etc. Structured data may be stored in the digital storage such as in a database. The server 841 may have a processor 1000 that is physically configured according to computer executable instructions. It may also have a sound and video module 1005 which assists in displaying video and sound and may turn off when not in use to conserve power and battery life. The server 841 may also have volatile memory 1010 and non-volatile memory 1015.

The database 1025 may be stored in the memory 1010 or 1015 or may be separate. The database 1025 may also be part of a cloud of computing device 841 and may be stored in a distributed manner across a plurality of computing devices 841. There also may be an input/output bus 1020 that shuttles data to and from the various user input devices such as the microphone 806, the camera 808, the inputs such as the input pad 804, the display 802, and the speakers 810, etc., The input/output bus 1020 also may control of communicating with the networks, either through wireless or wired devices. In some embodiments, the application may be on the local computing device 801 and in other embodiments, the application may be remote 841. Of course, this is just one embodiment of the server 841 and the number and types of portable computing devices 841 is limited only by the imagination.

The user devices, computers and servers described herein may be computers that may have, among other elements, a microprocessor (such as from the Intel® Corporation, AMD®, ARM®, Qualcomm®, or MediaTek®); volatile and non-volatile memory; one or more mass storage devices (e.g., a hard drive); various user input devices, such as a mouse, a keyboard, or a microphone; and a video display system. The user devices, computers and servers described herein may be running on any one of many operating systems including, but not limited to WINDOWS®, UNIX®, LINUX®, MAC® OS®, iOS®, or Android®. It is contemplated, however, that any suitable operating system may be used for the present invention. The servers may be a cluster of web servers, which may each be LINUX® based and supported by a load balancer that decides which of the cluster of web servers should process a request based upon the current request-load of the available server(s).

The user devices, computers and servers described herein may communicate via networks, including the Internet, wide area network (WAN), local area network (LAN), Wi-Fi®, other computer networks (now known or invented in the future), and/or any combination of the foregoing. It should be understood by those of ordinary skill in the art having the present specification, drawings, and claims before them that networks may connect the various components over any combination of wired and wireless conduits, including copper, fiber optic, microwaves, and other forms of radio frequency, electrical and/or optical communication techniques. It should also be understood that any network may be connected to any other network in a different manner. The interconnections between computers and servers in system are examples. Any device described herein may communicate with any other device via one or more networks.

The example embodiments may include additional devices and networks beyond those shown. Further, the functionality described as being performed by one device may be distributed and performed by two or more devices. Multiple devices may also be combined into a single device, which may perform the functionality of the combined devices.

The various participants and elements described herein may operate one or more computer apparatuses to facilitate the functions described herein. Any of the elements in the above-described Figures, including any servers, user devices, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++, or Perl using, for example, conventional or object-oriented techniques.

The software code may be stored as a series of instructions or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

It may be understood that the present invention as described above may be implemented in the form of control logic using computer software in a modular or integrated manner. Based on the disclosure and teachings provided herein, a person of ordinary skill in the art may know and appreciate other ways and/or methods to implement the present invention using hardware, software, or a combination of hardware and software.

The above description is illustrative and is not restrictive. Many variations of embodiments may become apparent to those skilled in the art upon review of the disclosure. The scope embodiments should, therefore, be determined not with reference to the above description, but instead should be determined with reference to the pending claims along with their full scope or equivalents.

One or more features from any embodiment may be combined with one or more features of any other embodiment without departing from the scope embodiments. A recitation of “a”, “an” or “the” is intended to mean “one or more” unless specifically indicated to the contrary. Recitation of “and/or” is intended to represent the most inclusive sense of the term unless specifically indicated to the contrary.

One or more of the elements of the present system may be claimed as means for accomplishing a particular function. Where such means-plus-function elements are used to describe certain elements of a claimed system it may be understood by those of ordinary skill in the art having the present specification, figures and claims before them, that the corresponding structure includes a computer, processor, or microprocessor (as the case may be) programmed to perform the particularly recited function using functionality found in a computer after special programming and/or by implementing one or more algorithms to achieve the recited functionality as recited in the claims or steps described above. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one embodiments to the embodiments illustrated.

The present disclosure provides a solution to the long-felt need described above. In particular, the systems and methods overcome challenges with traditional approaches to credit or loan lending—credit scores of owners of a business—rather than health of the actual business. Embodiments obtain direct and pertinent information about the transactional history and health of the business operations through data and information obtained from the payment processing network. Such information is the primary data source to determine a credibility of the business and its needs for credit or loan.

Further advantages and modifications of the above described system and method may readily occur to those skilled in the art.

The disclosure, in its broader aspects, is therefore not limited to the specific details, representative system and methods, and illustrative examples shown and described above. Various modifications and variations may be made to the above specification without departing from the scope or spirit of the present disclosure, and it is intended that the present disclosure covers all such modifications and variations provided they come within the scope of the following claims and their equivalents.

What is claimed is:

1. A computer-implemented method for conducting credit issuance via a computer network platform comprising:
receiving, via a graphical user interface (GUI), a loan request from a merchant by a server, the GUI comprising data fields for receiving data including a merchant ID associated with the server and an amount of the loan request;
based on the merchant ID, identifying, by the server, one or more of the following data without obtaining a credit rating of the merchant from a credit agency: historical data of transactions processed between the server and the merchant, a location of the merchant, a peer group of the merchant, and statistical data of performance of the merchant;
generating, by the server, a credibility score based on the one or more identified data of the merchant;
providing, by the server, the credibility score to one or more lenders; and
receiving, by the server, a result of the loan request from the one or more lenders.

2. The computer-implemented method of claim 1, further comprising providing, by the server, an installable software program to provide the GUI to the merchant.

3. The computer-implemented method of claim 1, further comprising providing, by the server, a software program to be downloaded to a mobile device accessible by the merchant.

4. The computer-implemented method of claim 1, further comprising receiving a request interest rate for the loan request.

5. The computer-implemented method of claim 1, wherein generating, by the server, comprises generating a maximum loan amount based on the generated credibility score.

6. The computer-implemented method of claim 5, further comprising providing, by the server, the maximum loan amount to the one or more lenders.

7. The computer-implemented method of claim 5, further comprising receiving from the merchant a different amount in response to the received maximum loan amount.

8. A computer-implemented method for conducting credit issuance via a computer network platform comprising:
receiving, via a graphical user interface (GUI), a loan request from a merchant by a server, the GUI comprising data fields for receiving data including a merchant ID associated with the server and an amount of the loan request;
based on the merchant ID, identifying, by the server, one or more of the following data without obtaining a credit rating of the merchant from a credit agency: historical data of transactions processed between the server and the merchant, a location of the merchant, a peer group of the merchant, and statistical data of performance of the merchant;
generating, by the server, a credibility score based on the one or more identified data of the merchant;
generating, by the server, a maximum loan amount based on the credibility score; and
providing, by the server, the credibility score to one or more lenders.

9. The computer-implemented method of claim 8, further comprising providing, by the server, a software program to be downloaded to a mobile device accessible by the merchant.

10. The computer-implemented method of claim 8, further comprising receiving a request interest rate from the merchant for the loan request.

11. The computer-implemented method of claim 8, further comprising providing, by the server, the maximum loan amount to the one or more lenders.

12. The computer-implemented method of claim 8, further comprising receiving, by the server, a result of the loan request from the one or more lenders

13. The computer-implemented method of claim 8, further comprising receiving from the merchant a different amount in response to the received maximum loan amount.

14. A system for conducting credit issuance via a computer network platform comprising:
a payment processing network for a connecting a borrower and one or more lenders;
a payment processing server configured to computer-executable instructions for:
receiving, via a graphical user interface (GUI), a loan request from a mobile device of the borrower by the payment processing server, the GUI comprising data fields for receiving data including a borrower ID associated with the server and an amount of the loan request;
based on the borrower ID, identifying one or more of the following data without obtaining a credit rating of the borrower from a credit agency: historical data of transactions processed between the server and the borrower, a location of the borrower, a peer group of the borrower, and statistical data of performance of the merchant;
generating a credibility score based on the one or more identified data of the borrower;
generating a maximum loan amount based on the credibility score; and
providing the credibility score to one or more lenders.

15. The system of claim 14, wherein the mobile device of the borrower is configured to execute a software program downloaded from the payment processing server.

16. The system of claim 14, wherein the mobile device is configured to receive a requested interest rate from the merchant for the loan request, wherein the mobile device is configured to transmit the requested interest rate to the payment processing server.

17. The system of claim 14, wherein the payment processing server is configured to provide the maximum loan amount to the one or more lenders.

18. The system of claim 14, wherein the payment processing server is configured to receive a result of the loan request from the one or more lenders

19. The system of claim 18, wherein the payment processing server is configured to provide the maximum loan amount to the mobile device of the borrower for acceptance.

20. The system of claim 19, wherein the payment processing server is configured to receive an acceptance of the result via the mobile device of the borrower.
